(19) United States
(12) Patent Application Publication
(10) Pub. No.: US 2016/0253893 A1
(43) Pub. Date: Sep. 1, 2016

(54) VEHICLE FOR DETECTING CHEMICAL LEAKAGE

(71) Applicant: KUO-CHI CHANG, NEW TAIPEI CITY (TW)

(72) Inventor: KUO-CHI CHANG, NEW TAIPEI CITY (TW)

(21) Appl. No.: 14/943,604

(22) Filed: Nov. 17, 2015

(30) Foreign Application Priority Data
Feb. 26, 2015 (TW) 104203025

(51) Int. Cl. G08B 21/18

(52) U.S. Cl. CPC G08B 21/18

(57) ABSTRACT

A vehicle for detecting chemical leakage includes an environment detecting unit, and a vehicle module, on which the environment detecting system is disposed. The environment detecting unit includes a detecting module, a processing module, and an alert module. The detecting module detects an environment parameter, and generates a detection signal accordingly. The processing module receives the detection signal and is configured to determine whether a hazard condition has occurred. The alert module is coupled to the processing module, and is controlled by the processing module to output an alert signal when it is determined by the processing module that the hazard condition has occurred.

### CROSS-REFERENCE TO RELATED APPLICATION

This application claims priority of Taiwanese Application No. 104203025, filed on Feb. 26, 2015.

### FIELD

The disclosure relates to a vehicle that includes mechanism for detecting chemical leakage.

### BACKGROUND

In an event of a chemical leakage, the personnel handling the situation are typically required to be heavily equipped (e.g., in chemical protection suits) in order to prevent exposure to the leaked chemical. It is known that many undesired accidents (e.g., fire, chemical gas exposure, low concentration of oxygen, liquid chemical spill, explosion, etc.) may occur in a scene of the chemical leakage. In that case, a plurality of environment parameters are required to be constantly monitored. However, it may be inconvenient for the heavily equipped personnel, who is (are) too occupied by other tasks to adequately monitor the environment parameters.

### SUMMARY

Therefore, an object of the disclosure is to provide a vehicle that can alleviate at least one of the drawbacks of the prior arts.

According to the disclosure, the vehicle is for detecting chemical leakage and includes an environment detecting unit, and a vehicle module, on which the environment detecting system is disposed.

The environment detecting unit includes a detecting module, a processing module and an alert module.

The detecting module is configured to detect an environment parameter, and to generate a detection signal accordingly.

The processing module is coupled to the detecting module for receiving the detection signal therefrom, and is configured to determine whether a hazard condition has occurred based on the detection signal.

The alert module is coupled to the processing module, and is controlled by the processing module to output an alert signal when it is determined by the processing module that the hazard condition has occurred.

### BRIEF DESCRIPTION OF THE DRAWINGS

Other features and advantages of the disclosure will become apparent in the following detailed description of the embodiments with reference to the accompanying drawings, of which:

FIG. 1 illustrating an embodiment of vehicle according to the disclosure;

FIG. 2 is a perspective view illustrating a door of the vehicle being in an open position; and

FIG. 3 is a block diagram illustrating an environment detecting unit disposed on the vehicle.

### DETAILED DESCRIPTION

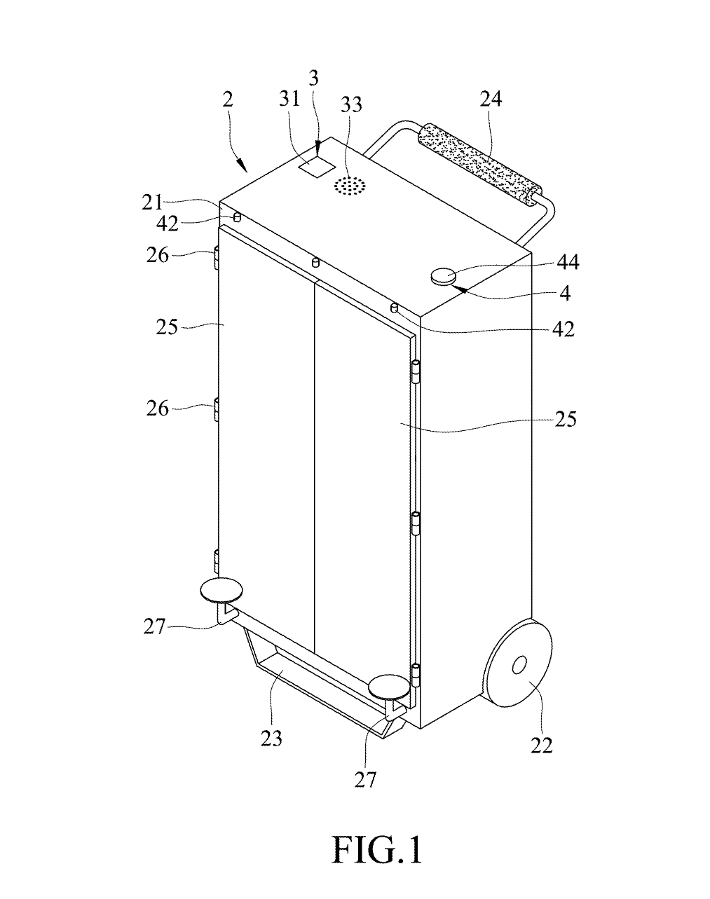

FIG. 1 illustrates a first embodiment of a vehicle for detecting chemical leakage. The vehicle includes a vehicle unit 2, an environment detecting unit 3, and an emergency response unit 4.

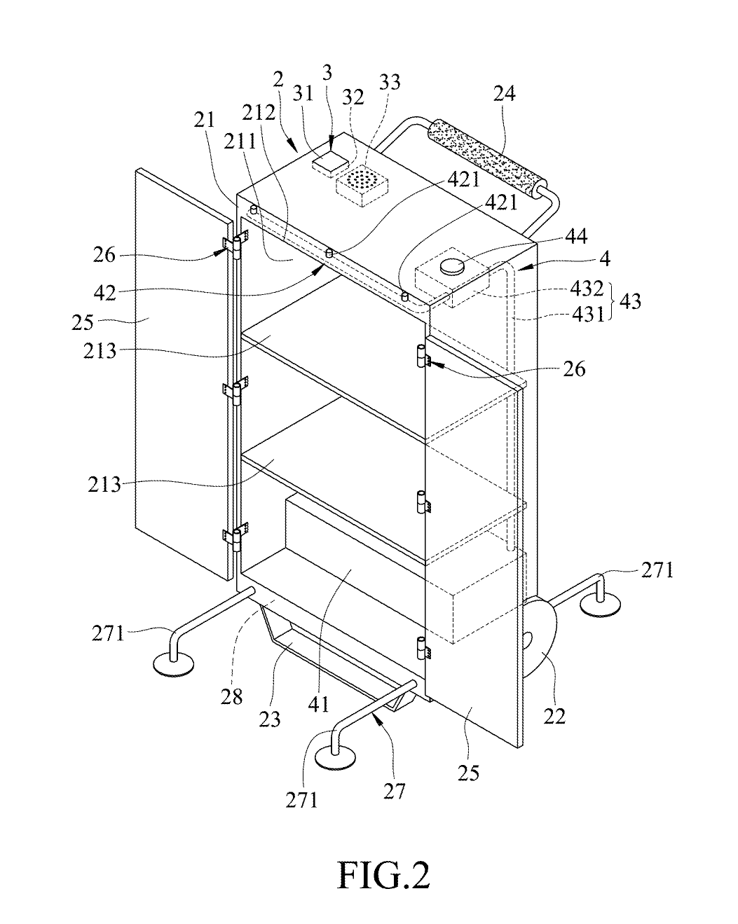

Further referring to FIG. 2, the vehicle unit 2 includes a main body 21, a wheel set 22 connected to the main body, a front stand 23, a handle 24, a pair of doors 25, a pair of securing members 26, and a supporting stand 27.

The main body 21 is dimensioned to have a cuboid shape, and has an opening 212, a containing space 211 that is in spatial communication with the opening 212, and a retaining space 28.

In this embodiment, the wheel set 22 and the front stand 23 are disposed respectively at opposite sides on a bottom surface of the main body 21. The handle 24 is disposed on a side surface of the main body 21, at a same side with the wheel set 22.

When the vehicle is to be mobilized, a user may grab the handle 24 of the main body 21 and push the same, driving the wheel set 22 to rotate. When the vehicle is to be temperately stopped, the user holding the handle 24 may slightly lean the main body 21 forward such that the front stand 23 contacts the ground and acts as a stand, bringing the vehicle to a stop.

The containing space 211 allows storage of equipment for handling situations related to chemical leakage, and includes a plurality of boards 213 for defining a plurality of compartments. In this embodiment, the equipments may include absorbent cotton, fixing equipment, waste disposal bags, chemical protection suits, gas masks, gloves, goggles, pH test papers, etc.

The opening 212 and the handle 24 (and the wheel set 22) are located at an opposite sides of the main body 21. In this manner, when the vehicle is moved to a scene of chemical leakage, the opening 212 faces the scene of chemical leakage for al lowing a more convenient access to the equipments stored in the containing space 211.

The doors 25 are disposed at the main body 21 for covering the opening 212. In this embodiment, the doors are pivotally connected to the main body 21 by the securing members 26, and are movable between an open position, in which the opening 212 of the main body 21 is uncovered, to a closed position, in which the opening 212 of the main body 21 is covered.

The securing members 26 are embodied using, for example, a door latch. When the doors 25 are moved to the open position, the securing members 26 are configured to prevent the doors 25 from moving from the open position to the closed position unassisted (i.e., without the user manually moving the doors 25). In this way, the doors 25 may further act as a barrier in the case of an accident (e.g., fire, spill, explosion, etc).

In other embodiments, only one door 25 may be employed, and the securing members 26 may be embodied using an automatic door operator.

The supporting stand 27 includes four corner stands 271, each disposed to correspond with a corner of the bottom surface of the main body 21. The supporting stand 27 is configured to move between a retracted position, in which the supporting stand is retracted inside the main body 21 (in the retaining space 28), and an extending position, in which the corner stands 271 of the supporting stand 27 extends outwardly from the main body 21 for making contact with the ground and for supporting the main body 21. The employment of the supporting stand 27 allows the vehicle to securely stand on the ground even though the vehicle is located on a non-flat ground surface. Additionally, the supporting stand 27 may allow the vehicle to withstand strong external forces such as a blast.

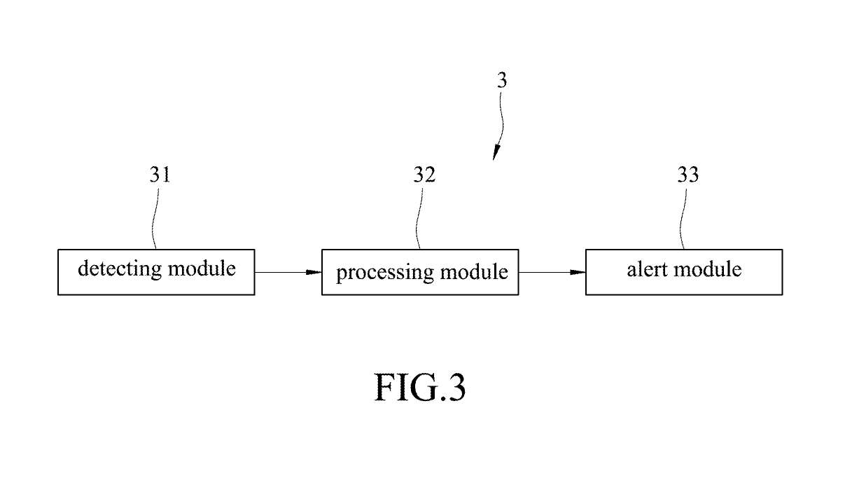

The environment detecting unit 3 is removably disposed on a top surface of the main body 2, and includes a detecting module 31, a processing module 32, and an alert module 33 (see FIG. 3).

The detecting module 31 is configured to detect an environment parameter, and to generate a detection signal accordingly. In this embodiment, the detecting module 31 includes an active radio frequency identification (RFID) tag, a catalytic combustion detector, and a electrochemical probe. In other embodiments, the RFID tag employed may be passive or battery-assisted passive.

The environment parameter that can be detected by the detecting module 31 may include: a temperature (e.g., between 0 to 500 Calcium degrees), a humidity, an oxygen concentration, a carbon dioxide concentration, a concentration of a chemical substance (e.g., ranging from 3% to 80%, and to be compared with a permissible exposure limit (PEL)), and a concentration of a combustible substance (e.g., ranging from 3% to 80%, and to be compared with a lower explosive limit (LEL)).

In other embodiments, various detectors may be incorporated to detect additional environment parameters such as a concentration of a toxic gas (e.g., ranging from 10 to 5000 ppm), a concentration of a corrosive vapor (e.g., ranging from 50 ppm to 50%), a strength of a shaking of the ground (measured in gals and ranging from 5 to 200 gals), an air pressure (ranging from 0.1 kg/cm² to 100 kg/cm²), an existence of ultraviolet (UV) and infrared radiation (IR) (i.e., radiation having a wavelength ranging from 20 to 11000 nanometers), a rate of obscuration (e.g., ranging from 1% to 100%).

In other embodiments, the detecting module 31 may further include an image capturing module for obtaining at least one of an image and a thermogram.

The processing module 32 is coupled to the detecting module 31 for receiving the detection signal therefrom. The processing module 32 is configured to determine whether a hazard condition (for example, a low oxygen concentration, a high concentration of a combustible substance, an image indicating so, etc.) has occurred based on the detection signal. Setting of the processing module 32 may be obvious to ones skilled in the art, and details thereof are omitted herein for the sake of brevity.

The alert module 33 is coupled to the processing module 32, and is controlled by the processing module 32 to output an alert signal when it is determined by the processing module 32 that the hazard condition has occurred. In this embodiment, the alert module 33 includes a buzzer for outputting a low-frequency audio signal when it is determined by the processing module 32 that no hazard condition occurred, and for outputting a high-frequency audio signal when it is determined by the processing module 32 that the hazard condition has occurred.

In other embodiments, the alert module 33 may include various components (e.g., a display module, a light-emitting module, a vibrating module, a sound generating module, or a combination thereof) in order to produce other forms of alert signal.

In this way, the personnel that is/are working near the vehicle may be notified of the occurrence of the hazard condition, and take corresponding actions.

One advantage of the vehicle as described is that the environment detecting unit 3 is a component that is removably connected to the main body 21, which itself can be mobilized as a part of the vehicle. Therefore, with different kinds of detectors attached, the vehicle may be applicable in various situations at various locations.

The emergency response module 4 includes a storage 41, a sprinkler module 42, a drive module 43 connected between the storage 41 and the sprinkler module 42, and a switch 44.

The storage 41 is disposed in the containing space 211 for storing a substance (e.g., water) therein.

The sprinkler module 42 includes a plurality of sprinklers for sprinkling the substance stored in the storage 41. In this embodiment, each of the sprinklers is disposed on the main body 21, and includes a spray nozzle disposed to sprinkle the substance at an angle of elevation (e.g., 45 degrees for maximize a range which the sprinkled substance covers).

The drive module 43 includes a supply line 431 connected between the storage 41 and the sprinkler module 42, and a compressing motor 432.

The switch 44 is coupled to the drive module 43. When actuated, the switch 44 enables the drive module 43 to supply the substance to the sprinkler module 42. In particular, the compressing motor 432 is configured to apply a pressure to the substance stored in the storage 41, and to supply the substance to the sprinkler module 42.

The emergency response module 4 is designed to allow the user to perform emergency response when it is determined that the hazard condition has occurred. For example, water may be sprinkled to lower ambient temperature, to extinguish a fire, and/or to prevent an explosion. In other embodiment, various substances may be employed to fit in other situations.

To sum up, the vehicle as described in the disclosure is capable of storing equipment for handling the chemical leakage, and automatically detecting various environment parameters. Additionally the vehicle can be mobilized to be used in various locations, and can provide emergency response measure in case that the hazard conditions becomes severe.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A vehicle for detecting chemical leakage, comprising:
an environment detecting unit including
a detecting module that is configured to detect an environment parameter, and to generate a detection signal accordingly,
a processing module that is coupled to said detecting module for receiving the detection signal therefrom, and that is configured to determine whether a hazard condition has occurred based on the detection signal, and
an alert module coupled to said processing module, and is controlled by said processing module to output an alert signal when it is determined by said processing module that the hazard condition has occurred; and
a vehicle module on which said environment detecting system is disposed.

2. The vehicle of claim 1, wherein said vehicle module includes:
a main body having an opening and a containing space that is in spatial communication with the opening;
at least one door disposed at said main body for covering the opening; and
a wheel set connected to said main body.

3. The vehicle of claim 1, wherein said vehicle module includes a supporting stand for supporting said main body.

4. The vehicle of claim 3, wherein said supporting stand is configured to move between a retracted position, in which said supporting stand is retracted inside said main body, and an extending position, in which said supporting stand extends outwardly from said main body for supporting the same.

5. The vehicle of claim 1, wherein said vehicle module further includes a securing member that is configured to prevent said at least one door from moving from an open position, in which the opening of said main body is uncovered, to a closed position, in which the opening of said main body is covered.

6. The vehicle of claim 1, further comprising an emergency response module that includes:
a storage disposed in the containing space for storing a substance therein;
a sprinkler; and
a drive module connected between said storage and said sprinkler, said driver module being able to supply the substance to said sprinkler for sprinkling the same.

7. The vehicle of claim 6, wherein said sprinkler is disposed on said main body and includes a spray nozzle disposed to sprinkle the substance at an angle of elevation.

8. The vehicle of claim 6, wherein said alert module further includes a switch which, when actuated, enables said drive module to supply the substance to said sprinkler.

9. The vehicle of claim 1, wherein said processing module includes at least one of a radio frequency identification (RFID) tag, catalytic combustion detector, and a electrochemical probe.

10. The vehicle of claim 1, wherein the environment parameter includes at least of the following: a temperature, a humidity, an oxygen concentration, a carbon dioxide concentration, a concentration of a chemical substance, and a concentration of a combustible substance.

11. The vehicle of claim 1, further comprising an image capturing module for obtaining at least one of an image and a thermogram.

12. The vehicle of claim 1, wherein said alert module includes at least one of the following: a display module, a light-emitting module, a vibrating module, and a sound generating module.
